(19) United States
(12) Patent Application Publication
(10) Pub. No.: US 2005/0216797 A1
(43) Pub. Date: Sep. 29, 2005

(54) System for tracking defects in released software products ancillary to customer service inquiries telephoned to customer service centers

(75) Inventors: Timothy Alan Dietz, Austin, TX (US); Marques Benjamin Quiller, Pflugerville, TX (US)

Correspondence Address: Mark E. McBurney;International Business Machines Corporation, Intellectual Property Law Dept., Internal Zip 4054, 11400 Burnet Road,, Austin, TX, 78758, US

(73) Assignee: International Business Machines Corporation, Armonk, NY (US)

(21) Appl. No.: 10/763,096

(22) Filed: Jan. 22, 2004

(51) Int. Cl. G06K 5/04

(52) U.S. Cl. 714/699

(57) ABSTRACT

Defects in released computer software products may be tracked on a real-time basis by agents at service call centers simultaneously with the agents handling of the telephone inquiry to the call center. A computer controlled display is associated with the service center, a function on the display, ancillary to a customer telephone inquiry to the service center, prompts the service agent at the service center to interactively select a software defect category to which the inquiry may relate and there is an implementation responsive to a selection of a software defect category to interactively prompt the service agent during the telephone inquiry to interactively respond to a set of statistical questions related to the defect category. The system should also include a database associated with the service center for storing data representative of the responses of the service agent. At the end of the service call, the agent should have the option of entering or not entering his responses into the database.

### TECHNICAL FIELD

The present invention relates to a method of doing business with a computer system and program for tracking defects and the distribution of such defects in released software products being marketed by software suppliers.

### BACKGROUND OF RELATED ART

Over the past generation, businesses have been undergoing major changes in the ways that they conduct their business. One of the most dramatic trends has been in the reduction of employees, functions and facilities through the out sourcing of virtually anything that can be out sourced. This has made many businesses leaner and more competitive with significantly reduced staffs and facilities to be maintained. However, along with these advantages has come a loss in control of the performance of many functions, as well as a diminished ability to control the quality of the resulting products.

This diminished control on the part of the business developer of products has become most pronounced in the supplying of software or computer program products. Over its first forty years, prior to the 1980's, the software development environment was one in which an individual or a small dedicated group willing to put in long hard hours could create “elegant” software or “killer applications” directed to and effective in one or more of the limited computer system environments existing at the time. Unlike hardware or industrial product development, the development of software did not require substantial investment in capital equipment and resources. Consequently, in the software product field, the business and consumer marketplace to which the software is directed has traditionally expected short development cycles from the time that a computer need and demand became apparent to the time that a commercial software product fulfilling the need became available.

Unfortunately, with the explosion of computer usage and the resulting wide diversity of computer systems that must be supported by, or at least not incompatible with, each newly developed computer software product, the development cycles have become very complex. Even when the software product development is an upgrade of an existing product, every addition, subtraction or modification of the program could have an insignificant or a profound effect on another operating system or application program that must be supported.

During the evolution of the software industries over the past two decades it has been evident that developing software will be combined in new, often unforeseen, ways; and, thus, there is an increased likelihood that the individual developments will drive system programs that must be supported into inoperable states for certain purposes or under certain conditions. This changed development environment has caused many traditional and responsible software development houses to take the time and make the effort to resolve all potential incompatibilities with all existing and standard software before the new developed software products were commercially released. Unfortunately, the computer industry landscape is littered with the “corpses” of such responsible longer development cycle software houses that lost out to newer software product entrepreneurs that rushed to the market, or to buyers with products that were less than complete.

Whether the customer of a software supplier is acquiring the software for specific internal needs or to be incorporated into broader products to be marketed by the customer, dysfunctional software products from even one supplier can derail an entire enterprise with profound marketing or economic effects.

Nonetheless, the above-described competitive pressures have forced software suppliers to test software products until they reach “a good enough to be released” level, which is far less than perfect; it is a level that gives the supplier some level of comfort that the software product will function reasonably, and that any errors or defects that may occur are readily curable, either directly or at least in the next product release. To this end, the tracking of reported defects and the distribution of such reported defects has become vital to software suppliers. Such information is used to correct defects in existing products and to perform test planning for future releases of the software product.

Because most software products are released at an early stage and because such products need to be compatible with a variety of systems, platforms and other software, there is a great need for extensive customer service available by telephone at customer contact centers. Here again due to the highly competitive nature of the software industry, these contact service employees are generally low paid with lower end technical computer skills. Now, because of the extensiveness of the Internet or World Wide Web (“Web”) and its attendant IP telephony, as well as the ready global extent of normal PSTN (Public Switched Telephone Network) telecommunications, it is quite customary to run service call centers in countries other than the United States in which the software may be released. Thus, such service call centers are primarily involved in only giving advice on the inquiry made in the call. The call centers do not report defects in any organized manner, in which there is any categorization of errors. Any reporting of errors would be random and of no value to any development organization.

### SUMMARY OF THE PRESENT INVENTION

Accordingly, the present invention provides a system, method and computer program through which defects in released computer software products may be tracked on a real-time basis by agents at service call centers simultaneously with the agents handling of the telephone inquiries to the call center.

The present invention thus provides a telephone customer service system for marketed computer software products wherein service agents at remote service centers provide service and technical advice. The system includes an implementation for tracking defects in the software products comprising a computer controlled display associated with the service center, means on the display, ancillary to a customer telephone inquiry to the service center, for prompting the service agent at the service center to interactively select a software defect category to which the inquiry may relate, and means on said display responsive to a selection of a software defect category to interactively prompt the service agent during the telephone inquiry to interactively respond to a set of statistical questions related to the defect category. The system should also include a database associated with the service center for storing data representative of the responses of the service agent. At the end of the service call, the agent should have the option of entering or not entering his responses into the database. The system may also include means for analyzing the stored data in combination with means for distributing the results of the analysis to the developers of the marketed products. Finally, there may be provided means for enabling the service agent to enter unprompted general comments relative to defects so that the means for analyzing may consider such general comments.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a generalized view of an illustrative system showing a portion of a PSTN combined with a portion of an Internet or Web IP telephone network that may be used in the defect tracking of telephone call service centers according to the practice of the present invention;

FIG. 2 is a block diagram of a data processing system including a central processing unit and network connections via a communications adapter that is capable of implementing the interactive display telephone support stations, as well as servers in the network in the implementation of the present invention;

FIG. 3 is a diagrammatic illustration of an interactive display interface panel used by the agent at the call center to report on defects as a function simultaneously with and ancillary to the handling of customer service inquiries;

FIG. 4 is the display interface panel of FIG. 3, after the agent at the call center has identified and entered a category of defect;

FIG. 5 is an illustrative flowchart describing the setting up of the functions to track software product defects ancillary to customer service inquiries; and

FIG. 6 is a flowchart of an illustrative run of the program set up according to FIG. 5.

### DETAILED DESCRIPTION OF THE PREFERRED EMBODIMENT

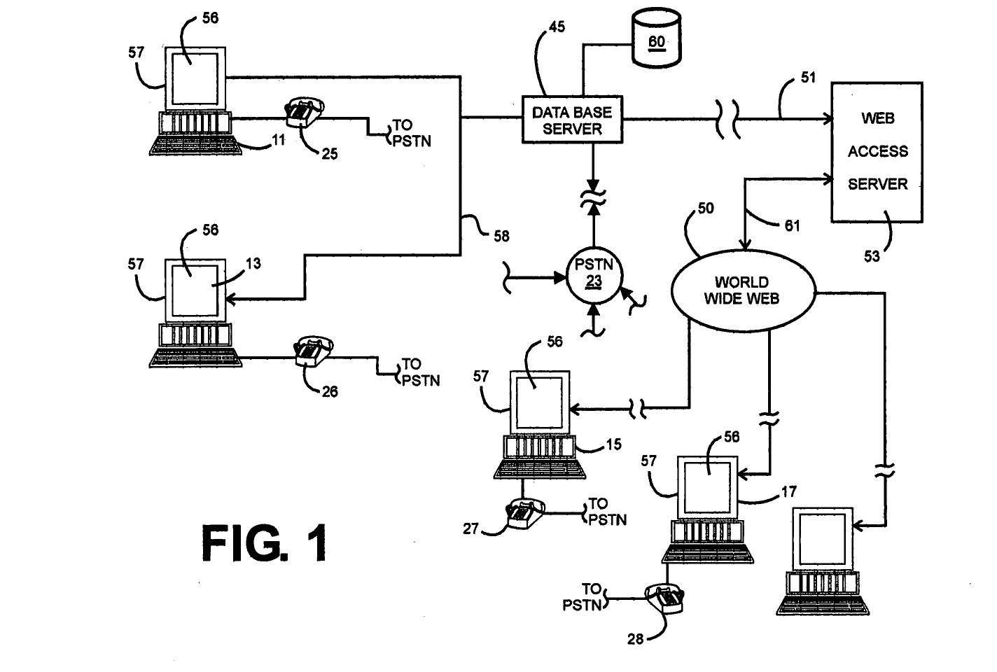

With reference to FIG. 1, there is shown a diagrammatic illustration of a portion of a PSTN combined with a portion of an Internet or Web IP telephone network that may be used in the defect tracking of telephone call service centers according to the practice of the present invention.

Before going further into the details of specific embodiments, it will be helpful to understand from a more general perspective the various elements and methods that may be related to the present invention. Since an aspect of the present invention is directed to both customer inquiries made over Internet IP networks and databases being accessed over the Internet or Web, an understanding of the Web and its operating principles would be helpful. We will not go into great detail in describing such networks to which the present invention is applicable. For details on Internet nodes, objects and links, reference is made to the text, Mastering the Internet, G. H. Cady et al., published by Sybex Inc., Alameda, Calif., 1996. The Internet or Web is a global network of a heterogeneous mix of computer technologies and operating systems. Higher level objects are linked to the lower level objects in the hierarchy through a variety of network server computers. The customer inquiries that are being monitored may be received via the traditional PSTN. There are also customer inquiries made via the Internet or Web IP telephony environment protocols. These are described in detail in the text, IP Telephony Demystified, Ken Camp, published 2003, McGraw-Hill, New York, N.Y., particularly in Chapter 4, pp. 97-117. The IP network is customarily connected into the PSTN via a gateway, not specifically shown, but which may be part of the Web Access Server system 53, FIG. 1. The IP Telephony Demystified text describes several conventional gateways between PSTN and IP telecommunications networks at Chapter 7, pp. 145-156.

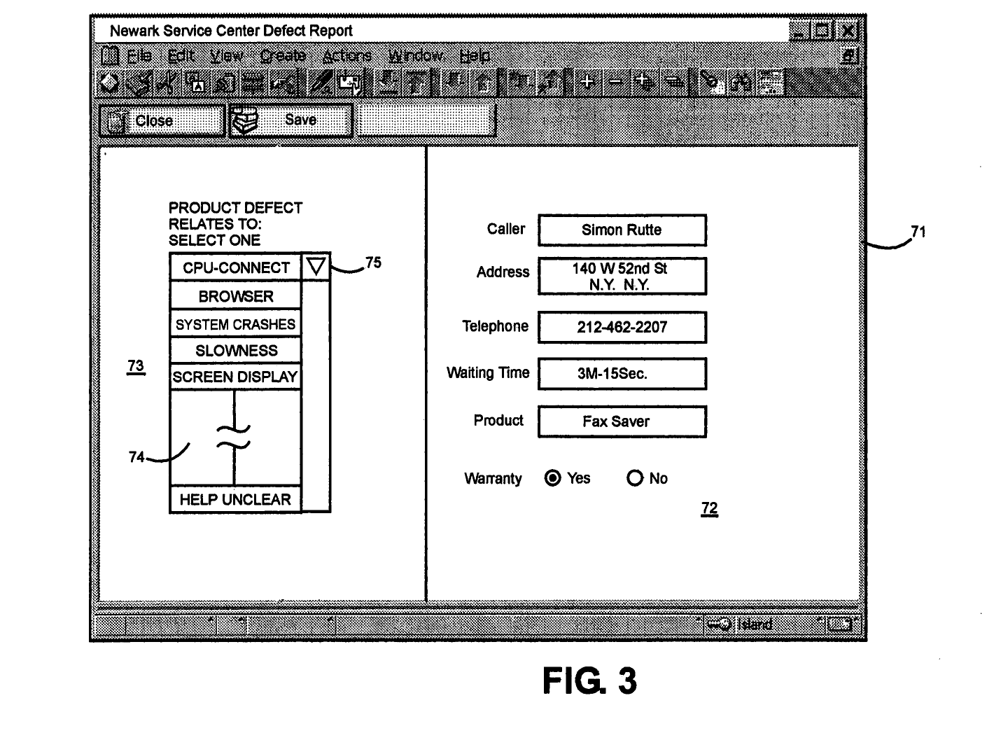

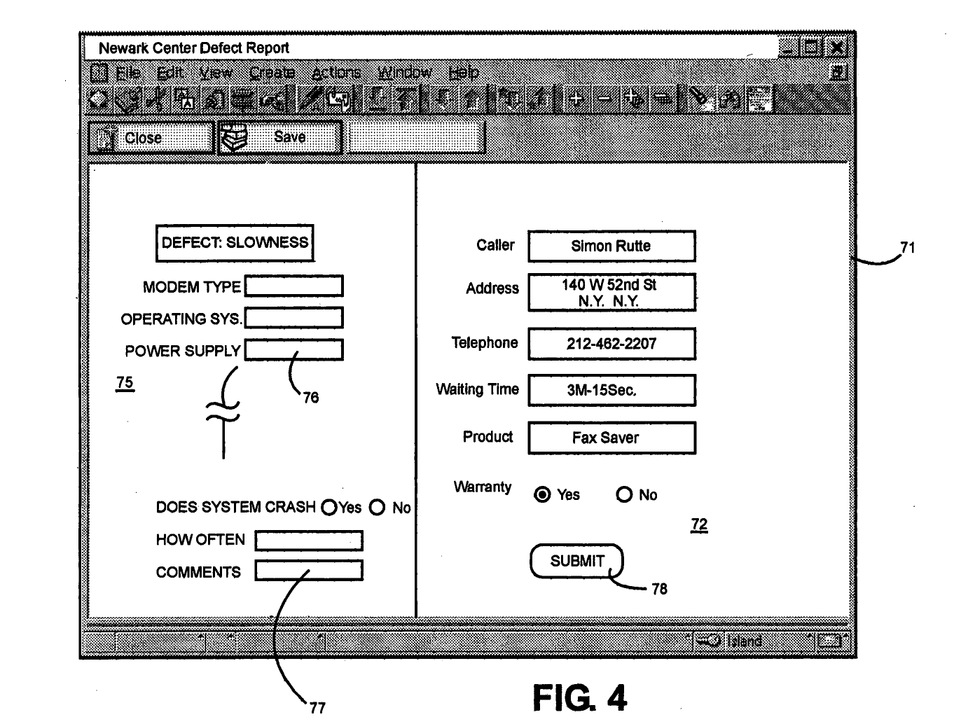

In the network set up of FIG. 1, four customer service centers are shown as represented by telephone stations 25, 26, 27 and 28. Each of these stations has respectively associated therewith a computer system 11, 13, 15 and 17 each of which has an interactive display 57 screen 56 through which the agent answering the inquiries may simultaneously be prompted to make the entries related to tracked software product defect, which will subsequently be described with respect to FIGS. 3 and 4. The telephone inquiries to call centers 25 and 26 are made through a conventional PSTN 23 while call centers 27 and 28 may receive customer telephone inquiries either via PSTN or through their respective computer systems 15 and 17 or via the above-described IP telephony connected to the Web 50.

Accordingly, the prompted data defect tracking input from service centers 25 and 26 may conveniently be input directly through database server 45 to database 60 where the tracked software product defect data may be stored. The same data from centers 25 and 26 may be sent by conventional telephone lines via PSTN 23 to database server 45. Similarly, the prompted data defect tracking input from service centers 27 and 28 may conveniently be input via Web 50 using the above-described IP Internet telephone protocols via connection 61 through Web server 53 and database server 45. In addition, the software supplier with access to the Web, e.g. at terminal 62, may access the database 60 via Web 50 so that the supplier may access defect analysis data.

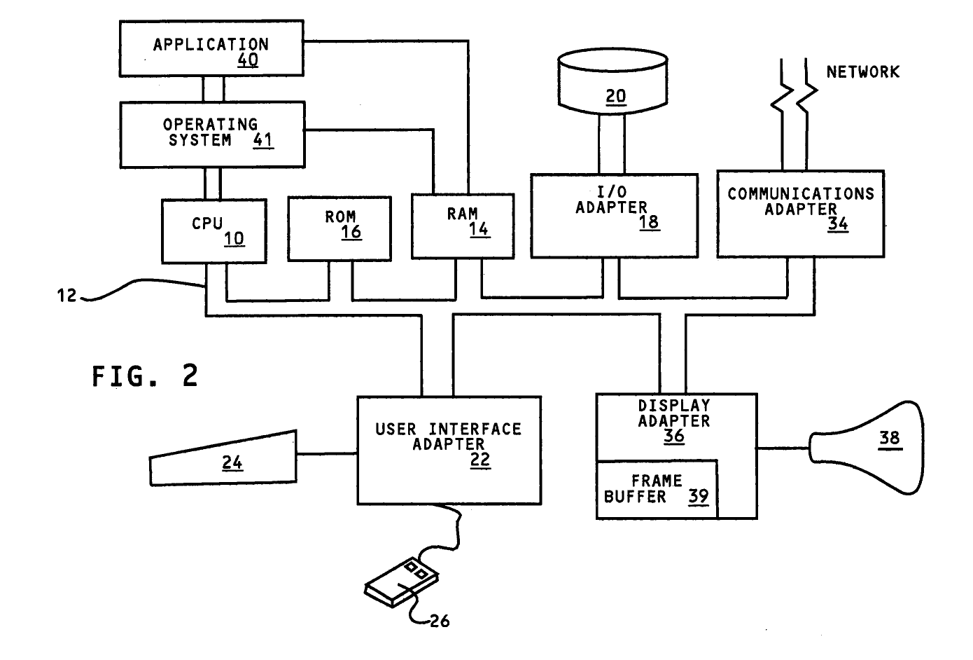

Referring to FIG. 2, a typical data processing system is shown that may function as the call centers supporting computers 11, 13, 15 and 17, network terminal 62 and for Web access server 53 or database server 45. A central processing unit (CPU) 10, may be one of the commercial microprocessors in personal computers available from International Business Machines Corporation (IBM) or Dell Corporation. When the system shown is used as a server computer at the Web distribution site, to be subsequently described, then a workstation is preferably used, e.g. RISC System/6000™ (RS/6000) series available from IBM. The CPU is interconnected to various other components by system bus 12. An operating system 41 runs on CPU 10, provides control and is used to coordinate the function of the various components of FIG. 1. Operating system 41 may be one of the commercially available operating systems such as the AIX 6000™ operating system available from IBM; Microsoft's Windows XP™ or Windows2000™, as well as UNIX and other IBM AIX operating systems. Application programs 40, controlled by the system, are moved into and out of the main memory Random Access Memory (RAM) 14. These programs include the programs of the present invention for tracking defects in software products ancillary to the processing of customer service center inquiries in accordance with this invention. Any conventional Web browser application program, such as Microsoft's Internet Explorer™, or Lotus Notes™ Personal Web Navigator or Server Web Navigator will be available on computer terminals 15, 17 and 62 setting up communication between the terminal and Web 50. A Read Only Memory (ROM) 16 is connected to CPU 10 via bus 12 and includes the Basic Input/Output System (BIOS) that controls the basic computer functions. RAM 14, I/O adapter 18 and communications adapter 34 are also interconnected to system bus 12. I/O adapter 18 communicates with the disk storage device 20. Communications adapter 34 interconnects bus 12 with the outside network enabling the computer system to communicate with other such computers over the Web or Internet. I/O devices are also connected to system bus 12 via user interface adapter 22 and display adapter 36. Keyboard 24 and mouse 26 are all interconnected to bus 12 through user interface adapter 22. It is through such input devices that the user at a receiving station may interactively relate to the Web in order to access Web documents and telecommunication packets. Display adapter 36 includes a frame buffer 39 that is a storage device that holds a representation of each pixel on the display screen 38. Images may be stored in frame buffer 39 for display on monitor 38 through various components, such as a digital to analog converter (not shown) and the like. By using the aforementioned I/O devices, a user is capable of inputting information to the system through the keyboard 24 or mouse 26 and receiving output information from the system via display 38.

Now, with respect to FIGS. 3 and 4, we will provide an illustrative example of how the present invention may be used to prompt the agent, answering a customer service call at a call center to solicit and enter software defect information simultaneously while he is responding to the customer inquiry. When the agent answers the next telephone inquiry, FIG. 3, the display screen illustrated in FIG. 3 comes up on the screen 56 of the display 57 on the telephone supporting computer 11 (FIG. 1). On screen half 72, FIG. 3, the normal customer service information 71 is displayed. While the service agent is dealing with the customer inquiry or problem, screen half 73 prompts the agent so that if during his conversation with the customer he notes that the discussion may relate to a defect in the software product being discussed, the agent is enabled to use scrolled 75 menu 74 to select a possible defect category. The agent then continues to try to advise the inquiring customer. However, if the agent has selected a defect category, e.g. slowness, then, as shown in FIG. 4, the agent is offered a set of entry prompts 76 and related questions pertinent to the selected defect category. The agent is also enabled to enter general comments concerning the possible defect. At the end of the service call, the agent is given a last opportunity to decide whether questions in the service inquiry actually did relate to the defect as he had originally thought or if, upon further discussion with the caller, he found the question did not involve a defect. Thus, the agent has the final option of submitting or not submitting via button 78. If submitted, the prompted information is transmitted to and stored in database 60 as described with respect to FIG. 1.

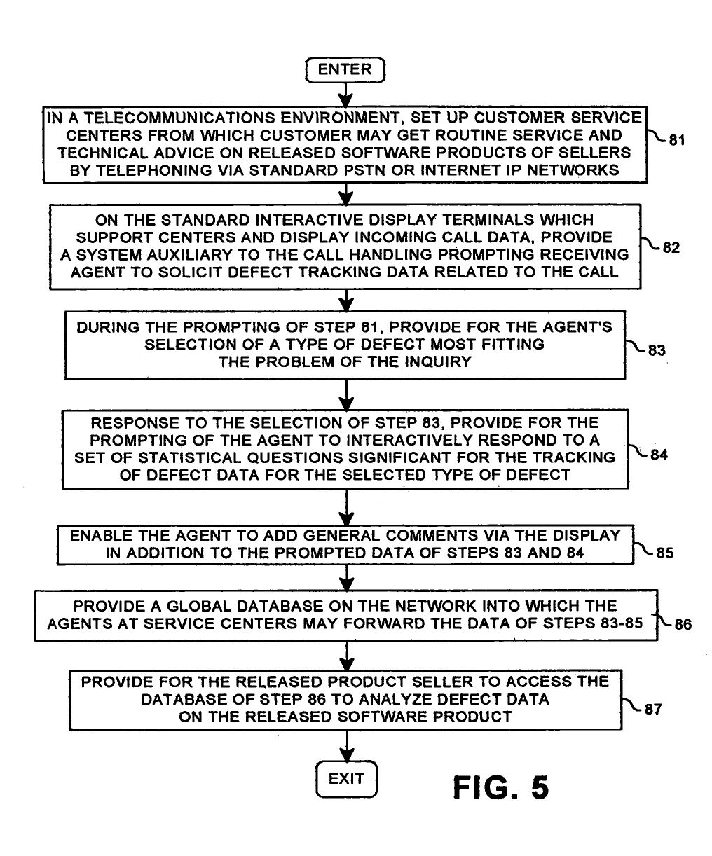

FIG. 5 is a flowchart showing the development of a process according to the present invention illustrative of how the present invention may be used to prompt the agent, answering a customer service call at a call center to solicit and enter software defect information simultaneously with his responding to the customer inquiry. In a telecommunications environment, there is set up customer service centers from which the customer may get routine service and technical advice on the released software products of sellers by telephoning via standard PSTN or Internet IP networks, step 81. On standard interactive display terminals that support call centers and display basic incoming call data, there is provided a system ancillary to the call handling that prompts the service agent to solicit defect data that is related to the call, step 82. During the prompting in step 82 there is provided to the service agent an implementation, should he determine that the call appears to relate to a product defect, for entering the type of defect, step 83. In response to an entry of a type of defect in step 83, there is provided for prompting of the service agent to interactively respond to a set of questions statistically significant for the tracking of defect data for the selected type of defect, step 84. The agent is also enabled to add general comments via the display in addition to the prompted data of steps 83, 84 and 85. There is provided a global database on the network into which the agent may forward the data of steps 83 through 85 collected at the service centers, step 86. Provision is made for the seller or supplier of released products to access the database of step 86 in order to analyze defect data on released software products, step 87.

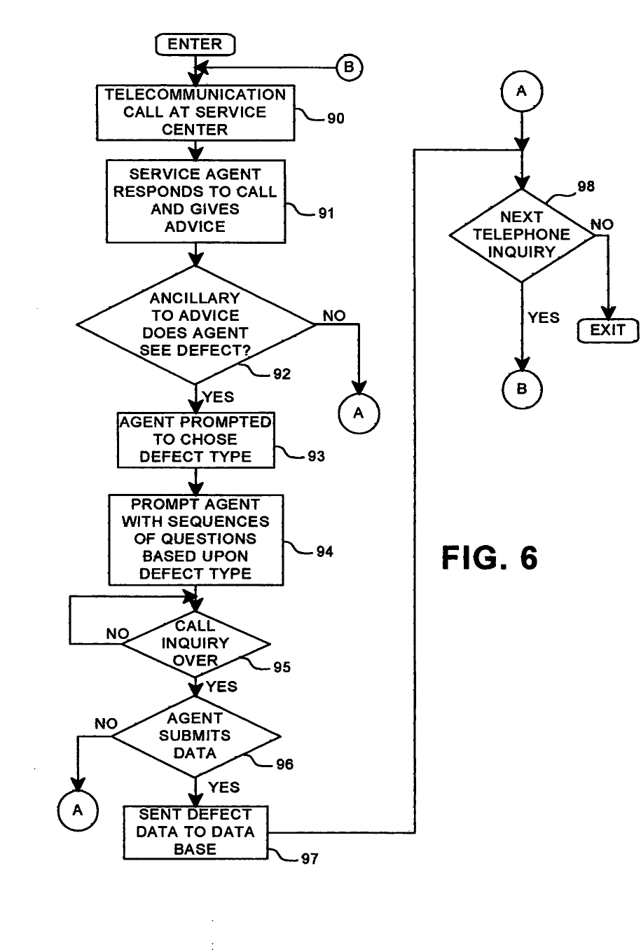

The running of the process set up in FIG. 5 and described in connection with FIGS. 3 and 4 will now be described with respect to the flowchart of FIG. 6. There is a customer service call at a call center, step 90. The agent at the call center responds to the call to give appropriate advice, step 91. The agent makes a determination, step 92, as to whether anything in the inquiry indicates a possible product defect, step 92. If Yes, the agent is prompted to select a defect type, step 93. Once a defect type has been selected, the agent is prompted to enter answers to a sequence of questions based upon the defect type, step 94. At this point, a determination is made as to whether the service call is over, step 95. If No, it continues. If Yes, the agent is given the option of submitting the defect data that he entered, step 96. If Yes, the defect data is sent to the database for such data, step 97. Then, or in the case of a No decision in either step 92 or 96 (via branch “A”), a determination is made in step 98 as to whether there is a next telephone service call. If Yes, the process is branched via “B” back to step 90. If No, the process is exited.

Although certain preferred embodiments have been shown and described, it will be understood that many changes and modifications may be made therein without departing from the scope and intent of the appended claims.

1. In a telephone customer service system for marketed computer software products wherein customers telephone service agents at remote service centers for service and technical advice, a system for tracking defects in said software products comprising:
a computer controlled display associated with said service center;
means on said display, ancillary to a customer telephone inquiry to said service center, for prompting said service agent at said service center to interactively select a software defect category to which said inquiry may relate; and
means on said display responsive to a selection of a software defect category, to interactively prompt said service agent, during said telephone inquiry, to interactively respond to a set of statistical questions related to the defect category.

2. The telephone customer service system of claim 1 further including database means associated with said service center for storing data representative of the responses of said service agent.

3. The telephone customer service system of claim 2 further including means enabling the service agent to optionally enter said data into said database.

4. The telephone customer service system of claim 3 wherein said means on said display for prompting said service agent prompt on a real-time basis coincident with the time during which the service agent responding within said telephone inquiry.

5. The telephone customer service system of claim 3 further including:
means for analyzing said stored data; and
means for distributing the results of the analysis to the developers of said marketed products.

6. The telephone customer service system of claim 5 further including:
means for enabling the service agent to enter unprompted general comments relative to defects; and
wherein said means for analyzing consider said general comments.

7. In a telephone customer service system for marketed computer software products wherein customers telephone service agents at remote service centers for service and technical advice including a computer controlled display, a method for tracking defects in said software products comprising:
during customer telephone inquiry to said service center, prompting said service agent at said service center to interactively select a software defect category to which said inquiry may relate; and
responsive to a selection of a software defect category, interactively prompting said service agent, during said telephone inquiry, to interactively respond to a set of statistical questions related to the defect category.

8. The telephone customer service method of claim 7 further including the step of storing data representative of the responses of said service agent.

9. The telephone customer service method of claim 8 further including the step of enabling the service agent to optionally enter said data into said database.

10. The telephone customer service method of claim 9 wherein said step of prompting said service agent prompts on a real-time basis coincident with the time during which the service agent responding within said telephone inquiry.

11. The telephone customer service method of claim 9 further including the steps of:
analyzing said stored data; and
distributing the results of the analysis to the developers of said marketed products.

12. The telephone customer service method of claim 11 further including the step of enabling the service agent to enter unprompted general comments relative to defects wherein said step of analyzing includes consideration of said general comments.

13. A computer program having code recorded on a computer readable medium for tracking defects in said software products in a telephone customer service system for marketed computer software products wherein customers telephone service agents at remote service centers supported by computer controlled displays for service and technical advice, said computer program comprising:
means on said display, ancillary to a customer telephone inquiry to said service center, for prompting said service agent at said service center to interactively select a software defect category to which said inquiry may relate; and
means on said display responsive to a selection of a software defect category, to interactively prompt said service agent, during said telephone inquiry, to interactively respond to a set of statistical questions related to the defect category.

14. The computer program of claim 13 further including database means associated with said service center for storing data representative of the responses of said service agent.

15. The computer program of claim 14 further including means enabling the service agent to optionally enter said data into said database.

16. The computer program of claim 15 wherein said means on said display for prompting said service agent prompt on a real-time basis coincident with the time during which the service agent responding within said telephone inquiry.

17. The computer program of claim 15 further including:
means for analyzing said stored data; and
means for distributing the results of the analysis to the developers of said marketed products.

18. The computer program of claim 17 further including:
means for enabling the service agent to enter unprompted general comments relative to defects; and
wherein said means for analyzing consider said general comments.
